(19) United States
(12) Patent Application Publication
(10) Pub. No.: US 2025/0286186 A1
(43) Pub. Date: Sep. 11, 2025

(54) BATTERY MODULE, AN ELECTRIC VEHICLE AND A METHOD FOR ASSEMBLING THE BATTERY MODULE

(71) Applicant: SAMSUNG SDI CO., LTD., Yongin-si (KR)

(72) Inventor: Matthias PUCHER, Ragnitz (AT)

(21) Appl. No.: 18/741,554

(22) Filed: Jun. 12, 2024

(30) Foreign Application Priority Data
Mar. 7, 2024 (EP) 24162162.2

(51) Int. Cl. H01M 50/233; H01M 50/249

(52) U.S. Cl. CPC H01M 50/233; H01M 50/249

(57) ABSTRACT

A battery module includes: a first end plate and a second end plate; a plurality of cells arranged between the first and the second end plates in a stacking direction; a plurality of side plates, a first end of each of the side plates being connected to the first end plate, and a second end of each of the side plates being connected to the second end plate; and a connecting system including a first joining element in the first end plate, a second joining element in one of the side plates, and a clamping element. The connecting system connects the first end of the one of the side plates and the first end plate by the first joining element, the second joining element, and the clamping element, and the connecting system is configured to vary a distance of the first end plate with respect to the second end plate by varying a relative position of the clamping element, the first joining element, and the second joining element with respect to each other.

### CROSS REFERENCE TO RELATED APPLICATION

The present application claims priority to and the benefit of European Patent Application No. 24162162.2, filed on Mar. 7, 2024, in the European Patent Office, the entire disclosure of which is incorporated herein by reference.

### BACKGROUND

### 1. Field of the Disclosure

Aspects of embodiments of the present disclosure relate to a battery module, an electric vehicle including the battery module, and a method for assembling the battery module.

### 2. Description of the Related Art

Recently, vehicles for transportation of goods and peoples have been developed that use electric power as a source for motion. Such an electric vehicle is an automobile that is propelled permanently or temporarily by an electric motor using energy stored in rechargeable (or secondary) batteries. An electric vehicle may be solely powered by batteries (referred to as Battery Electric Vehicle or BEV) or may include a combination of an electric motor and, for example, a conventional combustion engine (referred to as Plugin Hybrid Electric Vehicle or PHEV). BEVs and PHEVs use high-capacity rechargeable batteries, which are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions (e.g., lithium ions) during charging and discharging of the battery cell. The electrode assembly is located in (or is accommodated in) a casing, and electrode terminals, which are positioned on the outside of the casing, establish an electrically conductive connection to the electrodes. The shape of the casing may be, for example, cylindrical or rectangular.

A battery module is formed of a plurality of battery cells connected together in series or in parallel. That is, the battery module is formed by interconnecting the electrode terminals of the plurality of battery cells in various configurations depending on a desired amount of power and to realize a high-power rechargeable battery.

Battery modules can be constructed in either a block design or a modular design. In the block design, each battery is coupled to a common current collector structure and a common battery management system, and the unit thereof is arranged in a housing. In the modular design, pluralities of battery cells are connected to form submodules, and several submodules are connected to form the battery module. In automotive applications, battery systems often consist of a plurality of battery modules connected to each other in series to provide a desired voltage.

A battery pack is a set of any number of (often identical) battery modules. They may be configured in a series, parallel or a mixture of both to deliver the desired voltage, capacity, or power density. Battery packs include the individual battery modules and the interconnects, which provide electrical conductivity between them.

Mechanical integration of battery modules may be achieved by providing a carrier framework and by positioning the battery modules thereon. Fixing (or securing) the battery cells or battery modules may be achieved by forming fitted depressions in the framework or by mechanical interconnectors, such as bolts or screws. In some cases, the battery modules are confined by fastening side plates to lateral sides of the carrier framework. Further, end plates may be fixed atop and below or on the frontend and rearend sides, depending on installation orientation, of the battery modules.

Conventional approaches to battery module layout and assembly generally involve providing mechanical support for all integrated components (e.g., cells, spacers, etc.) by using the side plates and end plates. For the assembly itself, the cell stack is compressed either to a specific length or to a specific compression force. After the compression process, the end plates are assembled with the side plates to provide sufficient support of all integrated individual parts. Including a large number of individual components (e.g., cells, cell spacers, adhesive film layers, etc.), each having different dimensional tolerances, leads to a more or less complex tolerance chain. Thus, from a technical point of view (e.g., based on production process, functionality, service life, risks, etc.), the stack should be compressed to a specific force, regardless of the resulting compression type or length.

For the alternative, where the stack is compressed to a certain length, a corresponding “force window” must be defined, which is a compromise solution. The larger the tolerances of the individual parts, the larger the tolerance chain, and the larger the “force window”. Stable operation of the cell module in line with the process and safety requirements is therefore influenced by the resulting minimum and maximum compression forces after initial assembly.

The mechanical design of the cell stack/cell module ensures that it can withstand so-called “swelling forces” caused by internal chemical processes in the cells themselves during operation. Forces up to about 40 kN and more must be resisted by the end and side plates.

It is common to fix the end plates by conventional (e.g., laser) welding methods. As appropriately designed overlap area may be provided to accommodate different compression length values. Alternative mechanical fixings, such as conventional screw fixings in combination with longitudinal drilling, are usually not economically feasible for reasons of space and are technically unacceptable with regard to the transmission of high shear forces due to the relative movement of the clamped (or connected) parts.

Another typical requirement for the design of cell modules is that all contained parts must be protected against corrosion, depending on the application. Therefore, a rust-resistant and weldable material must be selected because a previously applied (or existing) coating is burned away by the welding process.

Common materials for the plates, such as stainless steel and aluminum, have only low yield strength values, which mean that the parts have to be designed with increased wall thickness to increase the loaded cross-sectional area to be able to transmit all of the mechanical stresses and loads, especially swelling forces. This leads to lower packing efficiency and generally higher costs; for example, the part weight increases due to the lower mechanical strength. With conventional steel, on the other hand, a suitable antirust coating must be applied. Welding is then no longer possible or is only available in combination with a subsequently applied coating, which is not cost-efficient because welding damages the coating.

### BRIEF SUMMARY

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery module includes a first end plate and a second end plate, a plurality of cells arranged between the first and the second end plates in a stacking direction, a plurality of side plates a first end of each of the side plates being connected to the first end plate, and a second end of each of the side plates being connected to the second end plate, and a connecting system including a first joining element assigned to the first end plate, a second joining element assigned to one of the side plates, and a clamping element. The connecting system connects the first end of the one of the side plates and the first end plate by the first joining element, the second joining element, and the clamping element, and the connecting system is configured to vary a distance between the first end plate to the second end plate depending on a relative position of the clamping element, the first joining element, and the second joining element with respect to each other.

Another embodiment of the present disclosure provides an electric vehicle including at least one of the battery modules described above.

Another embodiment of the present disclosure provides to a method for assembly of a battery module including stacking cells between a first end plate and a second end plate in a stacking direction; arranging side plates between the first end plate and the second end plate and along opposite sides of the cells, respectively; connecting a first end of one of the side plates and the first end plate by using a first joining element in the first end plate, a second joining element in the one of the side plates, and a clamping element; and adjusting a distance between the first end plate and the second end plate and/or an initial compression force acting on the cells by varying a relative position of the clamping element, the first joining element, and the second joining element with respect to each other.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1A is a schematic top view of a battery module.

FIG. 1B is a schematic perspective view of a battery module.

FIG. 1C-1F are schematic front views of a battery module according to embodiments of the present disclosure.

FIG. 2A schematically illustrates a first compression force and compression lengths of a cell stack before connection to a side plate.

FIG. 2B schematically illustrates the connection of the cell stack shown in FIG. 2A with side plates.

FIG. 3A schematically illustrates a second compression force and a third compression length of a cell stack before connection to a side plate.

FIG. 3B schematically illustrates the connection of the cell stack shown in FIG. 3A with side plates.

FIG. 4A illustrates a connecting system of a battery module according to an embodiment of the present disclosure.

FIG. 4B illustrates an enlarged view of the connecting system shown in FIG. 4A.

FIG. 4C is a perspective view of the connecting system shown in FIG. 4A.

FIG. 4D illustrates different arrangements of the connecting system shown in FIG. 4A.

FIG. 5A is a sectional view of the connecting system shown in FIG. 4A.

FIG. 5B is a side view of the connecting system shown in FIG. 4A.

FIG. 6A is a cross-sectional surface of a side plate according to the related art.

FIG. 6B is a cross-sectional surface of a side plate according to an embodiment of the present disclosure.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure may, however, be embodied in various different forms and should not be construed as being limited to the embodiments illustrated herein. Rather, these embodiments are provided as examples so that this disclosure will be thorough and complete and will fully convey the aspects and features of the present disclosure to those skilled in the art. Accordingly, processes, elements, and techniques that are not considered necessary for those having ordinary skill in the art to have a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery module includes a first end plate and a second end plate (collectively referred to herein as “the end plates”). Cells (e.g., battery cells) are stacked in a stacking direction between the end plates. Further, the battery module includes side plates. A first end of each of the side plates is connected to the first end plate, and a second end of each of the side plates is connected to the second end plate. In addition, the battery module includes at least one connecting system including a first joining element for the first end plate and a second joining element for one of the side plates and a clamping element. The connecting system provides the connection between the first end of the one of the side plates and the first end plate by using the first joining element, the second joining element, and the clamping element and is configured to adjust a distance of the first end plate from (or relative to) the second end plate depending on the relative position of the clamping element, the first joining element, and the second joining element to each other.

Accordingly, each of the side plates extends along the stacking direction between the first and second end plates. Consequently, the cells stacked along the stacking direction are orthogonal to the side plates. The battery module may include two opposing side plates. The battery module may include four side plates in which adjacent ordered side plates are arranged orthogonally to each other. Accordingly, side plates are arranged in pairs opposite each other and form a frame surrounding (or extending around a periphery of) the stacked cells.

The side plates, in addition to the connecting system according to embodiments of the present disclosure, are provided with the end plates to constitute (or to form) a stable mechanical structure that supports the other components, such as cells and also spacers arranged between cells.

For example, the first and second joining elements are (or include or are formed of) joining interfaces, connecting elements, connecting interfaces, or connecting features, respectively. The first joining element of the connecting system is assigned to (e.g., is formed in or on) one of the two end plates. Thus, the first end plate includes the first joining element. The second joining element is assigned to (e.g., is formed in or on) one of the side plates. Thus, the side plate includes the second joining element. The connecting system enables the first end plate to be connected to the one of the side plates. For this purpose, the first and the second joining elements are arranged accordingly and then fixed by the clamping element. Therefore, the first joining element, the second joining element, and the clamping element, in combination with each other, provide the connection between the first end of the one of the side plates to the first end plate. In this regard, the elements of the connecting system are connected in a relative arrangement with respect to each other. Thus, the user specifies the final relative arrangement of these components, which then establishes the connection. By this relative arrangement with respect to each other, at the same time a relative arrangement between the side plate and end plate involved in the connection is defined. Thus, the relative arrangement of the elements of the connection system defines an arrangement between the one of the side plates and the first end plate. The relative arrangement between the one of the side plates and the first end plate is thereby variable along the stacking direction. Consequently, if the second end plate and the one of the side plates are considered stationary, the relative arrangement of the first and second end plates changes. Consequently, the first end plate changes its arrangement (e.g., its position relative to the second end plate) along the stacking direction, for example, in one dimension, with a change possible in a positive and negative stacking direction. This ultimately changes the distance between the first end plate and the second end plate. Accordingly, the connecting system, according to embodiments of the present disclosure, allows for adjustment or varying of the distance between the first end plate and the second end plate during assembly.

The clamping element is a part that connects and braces the joining elements and may be referred to as a mating element.

The clamping element is designed to be stressed in shear. Compared to other connecting elements or components, such as screws, these can be stressed in shear (e.g., can withstand shear stress). With clamping elements that can be stressed in shear, slippage occurs in the parting line, but this is stopped as soon as the clamping elements abuts a tangential surface or a lateral surface of the plates.

Accordingly, a battery module that reduces costs and installation space is provided. Due to the connecting system, which includes the first joining element, the second joining element, and the clamping element, a joining process, such as welding, may be omitted. Accordingly, the use of stainless steel or aluminum can be dispensed with for the end plates and side plates because a coating can now be provided on the plates as they are not exposed to damage due to the absence of welding, so there is permanent corrosion protection.

In addition, materials can be used for the plates that have advantageous mechanical properties. The end plates and/or the side plates include steel, for example, high-strength steel. These have higher yield strengths than aluminum or stainless steel and have higher strength. This in turn allows the end plates and side plates to be thinner walled, providing smaller dimensions of the battery modules as well as lower weight. Also, openings, for example, to connect electrical poles or terminals, would pose significant stability and strength problems in the case of stainless steel compared with high-strength steel. Furthermore, steel is considerably less expensive than aluminum or stainless steel.

At the same time, the tolerance-related differences in dimensions in the stacking direction are considered because the connection system allows the distance between the two end plates to be adjusted or varied.

Furthermore, all mechanical requirements, for example resistance to swelling forces, are met and the connecting mechanism allows easy connection of an end plate to a side plate. Furthermore, the accessibility of suitable tools and equipment as well as a simple and cost-effective joining process is ensured.

According to one embodiment, the first joining element and the second joining element at least partially overlap and are disposed at an angle to each other. By overlapping the two joining elements and inclining them relative to each other, they form a variable area for establishing the connection between one of the first and second end plates and one of the side plates. The connection is made with the clamping element. Accordingly, the two plates can be moved relative to each other, thereby changing or varying the relative arrangement of the first and second joining elements and the clamping element to the two joining elements. Accordingly, the position of the connection changes. Thus, the distance between the two end plates is varied.

The second joining element is disposed in and parallel to a plane formed by a surface of the one of the side plates, and the first joining element is disposed parallel to the second joining element.

In an embodiment of the present disclosure, the first joining element and/or the second joining element include (or are formed of) an elongated hole or opening (e.g., a slot). An elongated hole refers to an elongated bore or slot. Its narrow sides are terminated by semicircles whose diameter corresponds to the width of the slot. The long sides of the elongated hole extend parallel to each other. This represents a particularly simple way of connecting the one of the side plates and the first end plate at a plurality of positions. The length of the elongated hole is defined from rounding center to rounding center. The clamping element has a round cross-sectional area, the diameter of which corresponds to the width of the two elongated holes, which have the same width. Thus, the elongated holes act as a guide within which the clamping element can move. This is a structurally simple way to implement the joining elements, which then creates the connection in combination with the clamping element. For example, tolerances that occur in the elongated holes can be easily compensated for because the elongated holes can be arranged in different positions relative to one another and a connection can still be made even if parts of the elongated holes do not form a continuous opening (e.g., do not entirely overlap) for the clamping element. The elongated holes at least partially overlap with each other and are disposed at an angle to each other. In other words, the elongated holes are arranged at least partially in one line extending in the stacking direction. As a result, the two elongated holes form a continuous opening when overlapping, which can be changed by shifting the two plates involved as previously described.

According to another embodiment, one of the first and second joining elements extends perpendicular to the stacking direction. This one of the first and second joining elements then represents a suitable contact pressure element which fixes the cell stack when the connection is made with the battery module mounted. The swelling forces that occur counteract, among other things, along the stacking direction and the initial compression force. The edge of the one of the first and second joining elements resists this force, which directly counteracts any force and prevents unwanted displacement.

The other of the first and second joining elements extends at an angle inclined to the one of the first and second joining elements in the direction of the stacking direction. For example, the other joining element is arranged inclined with respect to the joining element arranged perpendicular to the stacking direction. As used herein, the inclination in the stacking direction means that the other joining element is inclined along a direction including both a vectoral directional portion extending perpendicularly along the stacking direction and a vectoral portion extending along the stacking direction corresponding to a direction lying between the two portions. This provides a plurality of positions at which the connection can be made in combination with the clamping element, by displacing one of the first and second end plates and one of the side plates relative to each other along the stacking direction. This results in the two joining elements being displaced relative to each other, which also changes the arrangement of the clamping element relative to the two joining elements. This results in a simple and effective change in the distance between the two end plates.

According to another embodiment, the clamping element extends through the first and second joining elements. After arranging the two joining elements with respect to each other, they are connected and fixed by the clamping element, resulting in the connection of the first end plate and the one of the side plates. This eliminates the need for a joining method, such as welding. Instead, the clamping element together with the joining elements prevents a change in the relative arrangement with respect to each other so that the plates involved in the connection cannot move relative to each other.

According to another embodiment, the clamping element includes a blind rivet. By using a blind rivet, for example, a heavy-duty blind rivet, a high-strength connection can be achieved. Blind rivets are capable of transmitting very high shear forces. The type of blind rivet may be selected depending on the anticipated operating load, size, and number of connecting systems. In combination with the use of (e.g., high-strength) steel for the end plates and side plates, which may include appropriate corrosion protection, it is ensured that an anti-corrosion coating is not significantly damaged by the use of the blind rivets. Thus, a coating may be applied before assembly.

The first and the second joining element each include (or are) an elongated hole. One of the first and second joining elements is oriented vertically with respect to the stacking direction, and the other of the first and second clamping elements is oriented at an angle with respect to the one of the first and second clamping elements. The clamping element may include a blind rivet. The two elongated holes overlap each other. The blind rivet has a diameter equal to the width of the two elongated holes, which have an equal width. The two elongated holes, when overlapping each other, form a defined position due to their inclination to each other, which allows the blind rivet to protrude (or extend) through both holes. This position “wanders” or varies along a direction perpendicular to the stacking direction. The wandering occurs by moving one of the first and second end plates forward or backward in the stacking direction. Once a desired alignment of the plates has been achieved, the blind rivet is passed through both elongated holes and the joint is fixed. The connection, according to embodiments of the present disclosure, for example, when using the elongated holes and the blind rivets, makes it possible to use steel, for example high-strength steel, as the material for the end plates and side plates. Due to the strength of the high-strength steel, these components can be made relatively very thin-walled. Before the battery module is assembled, the plates made of the high-strength steel are coated with a corrosion inhibitor. The blind rivets they leave the coating essentially intact and do not cause any damage, so that no significant corrosion occurs. The risk of corrosion is also reduced because the connection with the rivets is a cold joining process that does not damage the coating.

The first joining element and the second joining element are configured such that the distance between the first end plate and the second end plate can be reduced by about 1 mm and increased by about 1 mm from a nominal arrangement (or nominal position). In other words, the distance between the first end plate and the second end plate is variable by a total of about 2 mm. The distance between the first end plate and the second end plate can be reduced by about 1 mm to about 1.5 mm and increased by about 1 mm to about 1.5 mm from the nominal arrangement.

The first joining element and the two joining elements, for example, when these are elongated holes, are arranged inclined to one another in such a way that, when the two joining elements are displaced relative to one another, the distance between the first end plate and the second end plate can be reduced by about 1 mm and increased by about 1 mm from a nominal arrangement. For example, the distance between the first end plate and the second end plate is variable by a total of about 2 mm. The distance between the first end plate and the second end plate can be reduced by about 1 mm to about 1.5 mm and increased by about 1 mm to about 1.5 mm from the nominal arrangement.

The possible tolerance compensation is determined according to the length of the two joining elements, for example, the length of the elongated holes and their angle to each other. The clamping element may be a blind rivet that is fixed by a clamping force. The clamping force must be greater than the resulting force based on the cell forces acting in the direction of the joining elements, for example, in the direction of the elongated holes (e.g., that are arranged at an angle to each other). As the angle between the two joining elements, for example, the elongated holes, increases, the resulting force increases. If a certain angle is exceeded, the resulting force exceeds the clamping force, as a result of which the blind rivet is pressed in the direction of the resulting force in the respective joining element, for example, along the elongated hole. The angle between the two elongated holes is, in various embodiments, less than about 45°, less than about 25°, between about 5° and about 25°, about 10° to about 20°, and, in one embodiment, in range of about 15° to about 18°.

The length of the joining elements, for example, the elongated holes, has a reduces the strength of the plates, so the length of the joining elements, for example, the elongated holes, should be less than a maximum value. The length of the elongated holes is, in various embodiments, about 3 mm to about 15 mm, about 6 mm to about 12 mm, and, in one embodiment, in a range of about 8 mm to about 10 mm.

One embodiment includes joining elements including elongated holes with an angle relative to each other in a range between about 13° and about 15° with a length of the elongated holes in a range of between about 8 mm and about 10 mm. The combination of features offers suitable tolerance compensation and the ability to absorb cell forces of up to about 40 kN.

The angles and lengths mentioned herein refer, for example, to battery modules with a height of about 100 to about 105 mm. For other heights, the lengths of the elongated holes and their number must be scaled accordingly. In one embodiment, four pairs of elongated holes per connection of one of the side plates with the first end plate (e.g., four first and second joining elements and four clamping elements) is provided, which includes a cumulative elongated hole length of about 36 mm for a length of about 8 mm to about 10 mm, for example, about 9 mm on average. In an embodiment in which an elongated hole is arranged perpendicular to the stacking direction, this length remains unchanged. Accordingly, the ratio of a cumulative hole length to the battery module height is about 0.34 to about 0.36. Accordingly, the number of elongated holes and/or their individual lengths should be adjusted for a battery module with a different height so that this ratio is maintained. For example, if a height of about 80 mm is present, the cumulative elongated hole length should be about 28 mm, which corresponds to a combination of three elongated holes with a single elongated hole length of about 9.3 mm, or alternatively, to improve force distribution, four elongated holes with a single elongated hole length of about 7 mm, which, neglecting the angle as another possible adjustment variable, would slightly reduce the tolerance compensation.

The connecting system includes a plurality of first and second joining elements, each including elongated holes. This provides a further distribution of forces. At least 1 to 5, 2 to 4, and, for example, 3 to 4 pairs of elongated holes are arranged per side. Accordingly, each connection system includes a plurality of clamping elements. In this way, the strength is maintained and, at the same time, a force distribution is achieved that avoids local load peaks on the panels.

According to another embodiment, the first end plate has an edge region in which the first joining element is provided and at where the one of the side plates overlaps. The edge region extends at a right angle to a major surface of the said end plate. For example, the edge region is angled so that it extends in the direction of the stacking direction, respectively parallel to the one of the side plates connected to the first side plate by the connecting system. The angled edge portion and the first end of the one of the side plates at least partially overlap each other so that they are arranged on top of each other, for example, flush with each other, and contact each other. This makes it easy to arrange the first and second joining elements for establishing the connection with the clamping element. In addition, access to the connecting system is simplified by the edge region and assembly is considerably easier to carry out.

According to another embodiment, the battery module includes a further (or second) connecting system that connects the first end of another one of the side plates and the first end plate. This improves mechanical stability by stabilizing and holding the cell stack on several sides. Furthermore, it is possible to adjust and compensate the spacing on several sides according to the tolerances.

According to another embodiment, the one and the other one of the side plates face each other. One of the side plates and the other one of the side plates are arranged opposite each other. In other words, they are arranged on opposite sides of the battery module. Due to the opposite arrangement of the involved side plates, the adjustment and compensation of the spacing of the endplates is possible because, usually, the tolerance occurs over the entire cross-section vertical to the stacking direction of the battery module.

According to another embodiment, the battery module further includes a plurality of side plates opposing each other in pairs and forming, with the end plates, a battery module cage framing (e.g., extending around a periphery of) the cells and a plurality of connecting systems. Each of the connecting systems connects the first end of each of the plurality of side plates and the first end plate. For example, each of the side plates is connected at its first end to the first end plate by the connecting system according to an embodiment of the present disclosure. The battery module may include four side plates. Accordingly, each two of the four side plates are arranged opposite each other to form a battery module cage having a rectangular cross-sectional area. This provides a battery module cage which, together with the end plates, fixes the cells and ensures mechanical stability. In addition, deviations may not occur evenly over the cross-section of the cells due to tolerances but rather may occur unevenly. The plurality of connecting systems can therefore take account of these possibly unevenly occurring deviations on different sides of the battery module and provide different distances or initial compression forces.

According to another embodiment, the battery module includes a further (or second) connecting system connecting the second end of the one of the side plates and the second end plate. This embodiment enables increased tolerance compensation. The connection of the corresponding components to the first and second end plates according to an embodiment of the present disclosure doubles the distance that can be used for compensated. For this second connecting system and for the second end plate, feature of the embodiments described above also apply in the presence of the further connecting system.

According to another embodiment, the relative position of the clamping element, the first joining element, and the second joining element is dependent on a desired distance between the first to the second end plate and/or on a desired initial compression force acting on the stacked cells. The arrangement according to an embodiment of the present disclosure ensures that a desired initial compression force is exerted on the cell stack. Despite differences in the dimensions of the battery module due to manufacturing and material technology as well as tolerances, this initial compression force is maintained because the distance between the first and second end plates can be varied. For example, the initial compression force is important to ensure safe operation, long battery life, and proper mechanical fixation of the cells inside the cell module or even the battery case. By connecting the end plates to the side plates at different positions, the assembly may be performed with compression up to a certain force, the compression length being variable and depending on the tolerance chain. If instead the same distance were specified for each battery module, this would result in different compression forces for each battery module. Therefore, the connection was made in such a way that the same predetermined initial compression force is consistently applied. However, it is also possible, if required by the corresponding application, to specify and implement a desired distance between the first and second end plates. Both approaches are made possible by embodiments of the present disclosure.

Expected relaxation mechanisms are considered so that the initial compression force does not fall below a desired limit value even over the life of the battery module.

According to another embodiment of the present disclosure, an electric vehicle including the battery module according to embodiments of the present disclosure is provided.

Another embodiment of the present disclosure refers to a method for assembly of a battery module including stacking cells between first and second end plates in a stacking direction, connecting a first end of one of the side plates and a first end plate by a first joining element in the one of the side plates, a second joining element in the first end plate, and a clamping element; and varying a distance between the first end plate to the second end plate and/or an initial compression force acting on the stacked cells based on a relative position of the clamping element, the first joining element, and the second joining element with respect to each other.

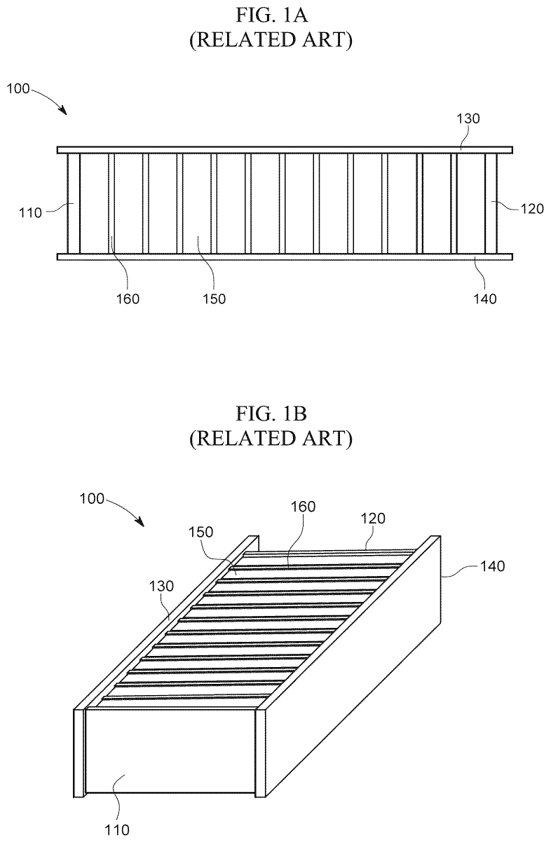

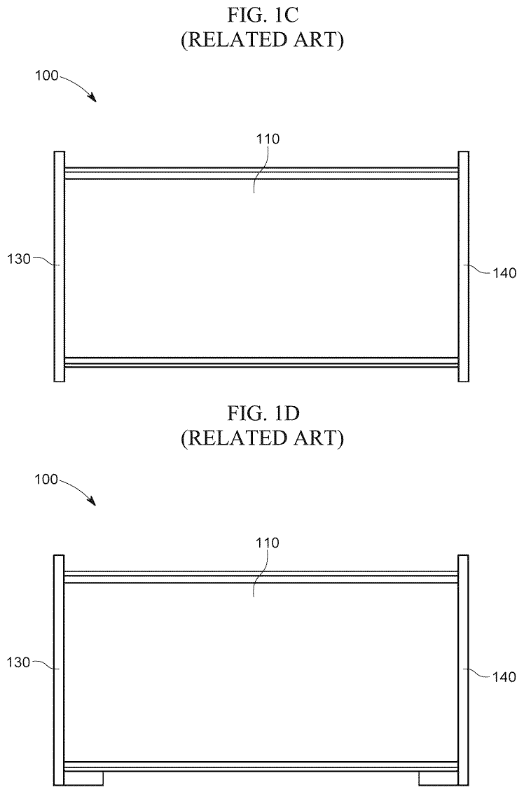

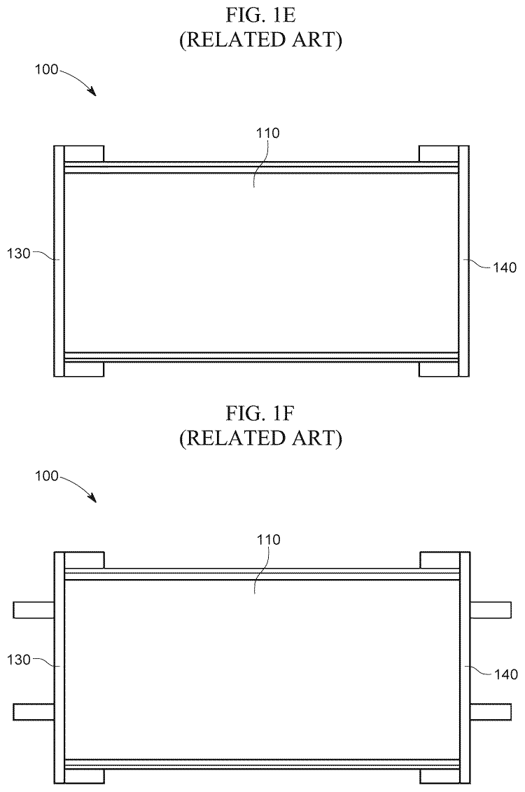

FIG. 1A is a schematic top view of a battery module 100, and FIG. 1B is a schematic perspective view of the battery module 100. Typical battery modules include two opposing side plates 130, 140 and first and second end plates 110, 120 disposed at the first and second ends of the two side plates 130, 140, respectively. The first and second end plates 110, 120 oppose each other and are oriented orthogonally to the side plates 130, 140. A plurality of individual battery cells 150 are disposed between the end plates 130, 140 along a stacking direction. Typically, spacers 160 are disposed between the cells 150. In some cases, intermediate layers may be disposed between the cells 150 with or without the spacers 160.

Depending on the purpose or desired application of the battery module 100, the side plates 130, 140 can be designed with different shapes, as shown in, for example, FIGS. 1C to 1F. Straight plates (e.g., FIG. 1C), an L-shaped design (e.g., FIG. 1D), a C-shaped design (e.g., FIG. 1E), or side plates with lateral fixing ribs or fixing tabs (e.g., FIG. 1F) may be used.

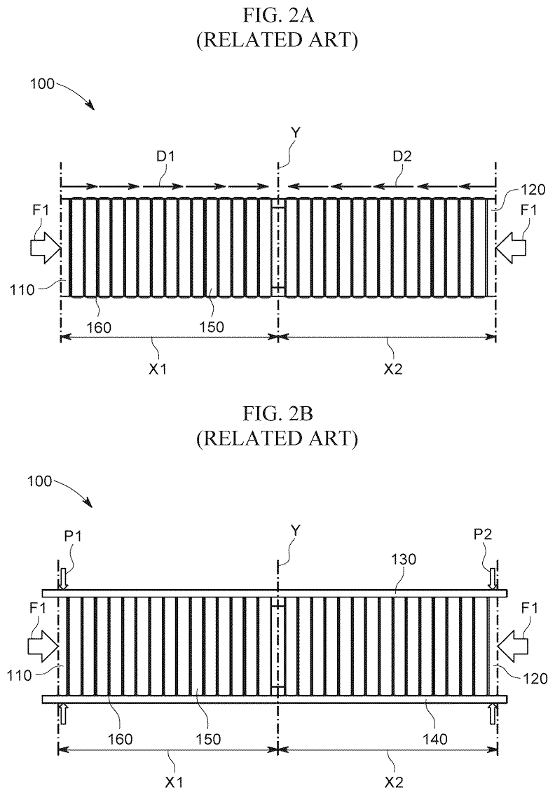

FIG. 2A schematically illustrates a first initial compression force F1 and compression lengths X1, X2 of a cell stack before connection of (or connection to) a side plate. In force-controlled compression, the cell stack is compressed by a suitable force without regard to (e.g., irrespective of) the total compression length including compression length X1 plus X2. Depending on the total tolerance chain, the support plane Y, effective single part tolerances and relaxation effects of the components, the compression length X1+X2 will be different each time (e.g., will be different for each battery module) due to differences in these parameters. It should be noted that the compression lengths X1 and X2 may not be equal in length. Depending on the individual application, they can be the same but may be different from each other.

FIG. 2B schematically illustrates the cell stack shown in FIG. 2A with side plates connected. In practice, the mechanisms and parameters described above lead to (or cause) the end plates to be joined to the side plates at different joining positions P1 and P2 in different battery modules.

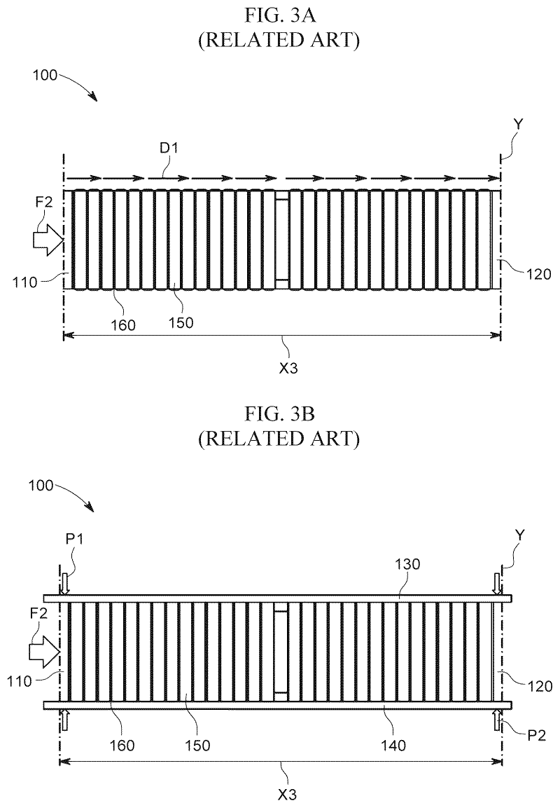

FIG. 3A schematically illustrates a second compression force F2 and a third compression length X3 of a cell stack before connection of a side plate. The third compression length X3 can be different each time depending on the application and does not necessarily correspond to X1 plus X2 as shown in FIGS. 2A and 2B. FIG. 3A shows that the support plane Y is located on one side of the battery module 100 and the force F2 acts in only one direction.

FIG. 3B schematically illustrates the resulting connection points P1 and P2 of the cell stack shown in FIG. 3A with side plates.

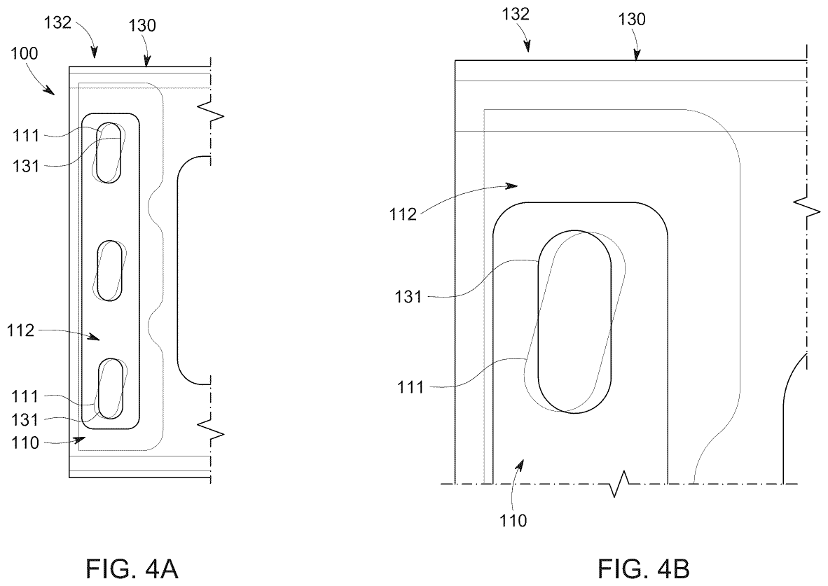

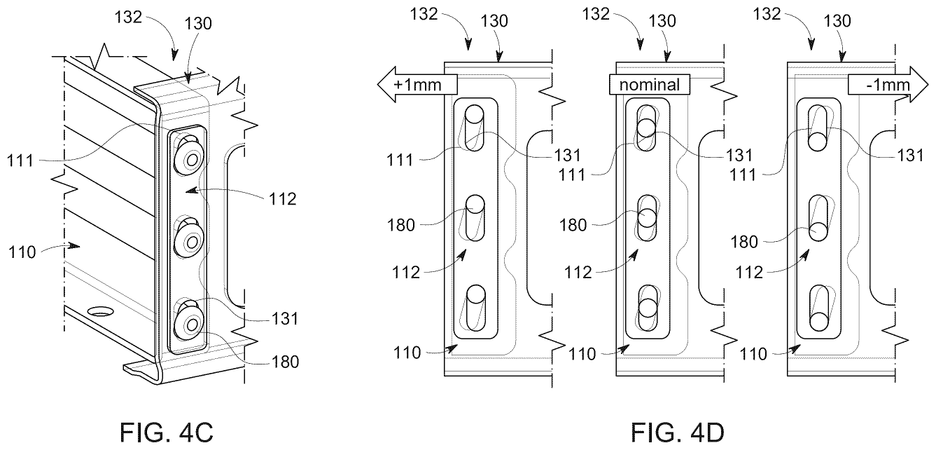

In FIG. 4A, a connecting system of a battery module 100 according to an embodiment of the present disclosure is shown. The connecting system includes a second joining element 131, which includes a second elongated hole (e.g., a second elongated opening or second slot) 131 orientated in a vertical direction with respect to the stacking direction and assigned to (e.g., formed on or in) one of the side plates 130. Further, the connecting system includes a first joining element 111 assigned to (e.g., formed on or in) the first end plate 110, the first joining element 111 including a first elongated hole (e.g., a first elongated opening or first slot) 111. The first elongated hole 111 is arranged at an angle or is slightly angled with respect to the second elongated hole 131. Both elongated holes 111, 131 are formed by recessing the respective end plates 110, 130 in which the elongated holes 111, 131 are formed, and therefore the elongated holes 111, 131 lie in a plane with the respective end plates 110, 130. The first and second elongated holes 111, 131 may have the same width as each other.

FIG. 4B shows an enlarged view of the connecting system shown in FIG. 4A and illustrates the arrangement of the two elongated holes 111, 131 relative to each other. As can be seen, the first joining element 111 is inclined (or angled) relative to the vertically arranged second joining element 131. Accordingly, the two elongated holes 111, 131 do not lie congruently one above the other. Consequently, they form an opening (e.g., an aligned opening between both elongated holes 111, 131) that is smaller than the opening of the elongated holes 111, 131 themselves. This opening has a widest point. Depending on the relative arrangement of the two elongated holes 111, 131, which can be varied by moving one of the first and second end plates 110, 120, this widest point can “move” upwards or downwards.

FIG. 4C is a perspective view of the connecting system shown in FIG. 4A. The connecting system includes a clamping element 180, which is, in one embodiment, heavy-duty blind rivet. The clamping element 180 is not limited thereto. The clamping element 180 has an axis with a circular cross-section and a diameter corresponding to (e.g., corresponding to a width of) the two elongated holes 111, 131. The clamping element 180 protrudes (or extends) through both elongated holes 111, 131, with the clamping element 180 protruding at the point where the opening formed by both elongated holes 111, 131 is widest. After mounting the clamping element 180, the first end 132 of the one of the side plates 130 and the first end plate 110 are fixed. This allows for a high strength connection with the ability to remain variable in compression length.

FIG. 4D shows different arrangements of the connecting system from that shown in FIG. 4A. In the middle illustration, the two elongated holes 111, 131 are arranged relative to each other such that the widest point of the opening formed by them (e.g., the widest point of an overlapping opening) is located in the middle of the two elongated holes. Starting from this position, the first end plate 110 can be moved along the stacking direction towards the second end plate 120, if necessary. As a result, the widest part of said opening “moves” downward as shown in the right-most illustration. Consequently, the clamping element 180 no longer protrudes through both elongated holes 111, 131 at the previous position but protrudes therethrough at the new lower position. Accordingly, the distance between first and second end plate 110, 120 is reduced. If desired, the connection is then fixed in that position. In the other case, shown on the left-most illustration, the first end plate 110 is moved along the stacking direction opposite the second end plate 120. Consequently, the clamping element 180 no longer protrudes through both elongated holes 111, 131 at the previous position but protrudes therethrough at the new upper position. Accordingly, the distance between the first end plate 110 and the second end plate 120 is increased. If desired, the connection is then fixed in that position. It can be seen that, the longer the elongated holes 111, 131 are and the larger the angle between the two elongated holes 111, 131 becomes, the greater the tolerance compensation value.

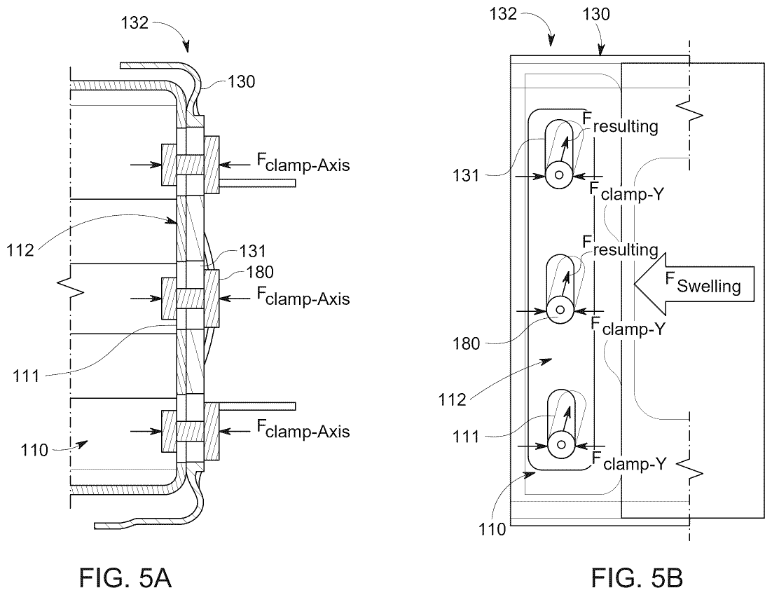

FIG. 5A illustrates a cross-sectional view and FIG. 5B illustrates a side view of the connecting system shown in FIG. 4A. The forces occurring there are schematically illustrated to explain the connection according to embodiments of the present disclosure. The oblique or slightly inclined elongated hole 111 in the first end plate 110 prevents the clamping element 180 from moving in the direction of the elongated holes 111, 113 due to the swelling forces F_{Swelling} that occur and/or prevents relative movement of the end plate 110, 120 with respect to the side plate 130. The slight inclination forces the clamping element 180 to wedge in the interface to produce a higher total clamping force, which is composed of a clamping force component F_{clamp-Y} and a clamping force component F_{clamp-Axis}, which exceeds the resultant vector force F_{resulting} that tends to push the clamping element 180 in the elongated hole direction. In other words, the sum of all effective clamping forces F_{clamp-Y} plus F_{clamp-Axis} is higher than the resulting vector force F_{resulting}.

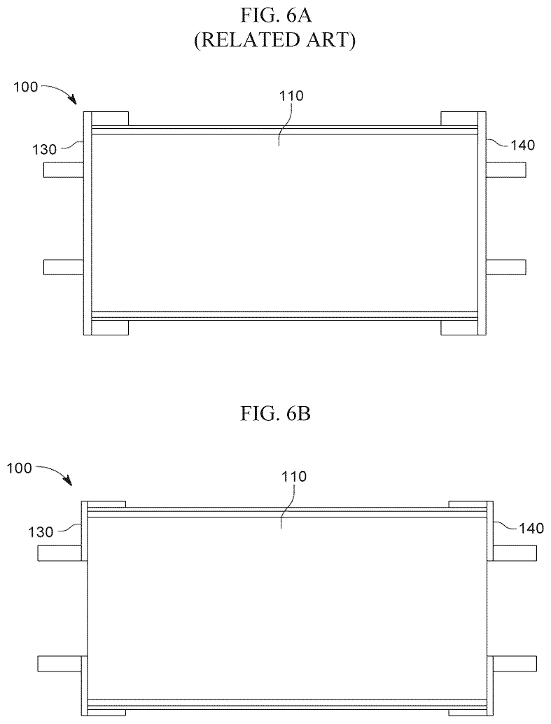

FIG. 6A illustrates a cross-sectional surface of side plates according to the related art. FIG. 6B illustrates a cross-sectional surface of side plates according to another embodiment of the present disclosure. With the connection according to embodiments of the present disclosure, it is possible, among other things, to use conventional steel parts with high stability and/or yield strength. As a result, the loaded cross-sectional area of the parts can be made thinner, which is a major advantage in terms of installation space, weight, and cost. This can be seen from the comparison of the two battery modules shown in FIGS. 6a and 6b. Because an anti-corrosion coating is not significantly damaged by the use of the blind rivet joint, it is possible to apply a coating in advance.

Some Reference Symbols

| | | | |
|---|---|---|---|
| 100 | battery module | 110 | first end plate |
| 111 | first joining element/first elongated hole | | |
| 112 | edge region of the first end plate | | |
| 120 | second end plate | 130 | one of the side plates |
| 131 | second joining element/second elongated hole | | |
| 132 | first end of the one of side plates | | |
| 140 | another one of the side plates | | |
| 142 | second end of the another one of the side plates | | |
| 150 | (battery) cells | 160 | spacer |
| 180 | clamping element/blind rivet | | |
| F1 | first initial compression force | | |
| F2 | second initial compression force | | |
| F_{Swelling} | swelling forces | F_{clamp-axis} | first clamp forces |
| F_{clamp-Y} | second clamp forces | F_{resulting} | resulting forces |
| X1 | first compression length | X2 | second compression length |
| X3 | third compression length | Y | support plane |
| D1 | first compression direction | D2 | second compression direction |
| P1 | first connection point | P2 | second connection point |
| w1 | first width of side plates | w2 | second width of side plates |

What is claimed is:

1. A battery module comprising:
a first end plate and a second end plate;
a plurality of cells arranged between the first and the second end plates in a stacking direction;
a plurality of side plates, a first end of each of the side plates being connected to the first end plate, and a second end of each of the side plates being connected to the second end plate; and
a connecting system comprising a first joining element in the first end plate, a second joining element in one of the side plates, and a clamping element,
wherein the connecting system connects the first end of the one of the side plates and the first end plate by the first joining element, the second joining element, and the clamping element, and
wherein the connecting system is configured to vary a distance of the first end plate with respect to the second end plate by varying a relative position of the clamping element, the first joining element, and the second joining element with respect to each other.

2. The battery module as claimed in claim 1, wherein the first joining element and the second joining element at least partially overlap each other and are disposed at an angle with respect to each other.

3. The battery module as claimed in claim 2, wherein the first joining element and/or the second joining element is an elongated hole.

4. The battery module as claimed in claim 1, wherein one of the first and second joining elements extends perpendicular to the stacking direction.

5. The battery module as claimed in claim 4, wherein the other one of the first and second joining elements extends at an angle inclined to the one of the first and second joining elements.

6. The battery module as claimed in claim 1, wherein the clamping element extends through the first and second joining elements.

7. The battery module as claimed in claim 1, wherein the clamping element comprises a blind rivet.

8. The battery module as claimed in claim 1, wherein the first end plate has an edge region where the first joining element is provided and where one of the side plates overlaps.

9. The battery module as claimed in claim 1, further comprising a second connecting system,
wherein the second connecting system connects the first end of another one of the side plates and the first end plate to each other.

10. The battery module as claimed in claim 9, wherein the one of the side plates and the other one of the side plates face each other.

11. The battery module as claimed in claim 1, wherein the side plates oppose each other in pairs and form, with the first and second end plates, a battery module cage extending around a periphery of the cells, and
wherein a plurality of the connecting systems, each of the connecting systems respectively connecting the first end of each of the plurality of side plates and the first end plate.

12. The battery module as claimed in claim 1, wherein the battery module further comprises a second connecting system,
wherein the second connecting system connects the second end of the one of the side plates and the second end plate to each other.

13. The battery module as claimed in claim 1, wherein the relative position of the clamping element, the first joining element, and the second joining element is based on a distance between the first end plate and the second end plate and/or is based on an initial compression force acting on the cells.

14. An electric vehicle comprising the battery module as claimed in claim 1.

15. A method for assembly of a battery module, the method comprising:
stacking cells between a first end plate and a second end plate in a stacking direction;
arranging side plates between the first end plate and the second end plate and along opposite sides of the cells, respectively;
connecting a first end of one of the side plates and the first end plate by using a first joining element in the first end plate, a second joining element in the one of the side plates, and a clamping element; and
adjusting a distance between the first end plate and the second end plate and/or an initial compression force acting on the cells by varying a relative position of the clamping element, the first joining element, and the second joining element with respect to each other.
